(19) United States
(12) Patent Application Publication
(10) Pub. No.: US 2002/0198847 A1
(43) Pub. Date: Dec. 26, 2002

(54) Communications services, methods and systems

(76) Inventor: Christer Fahraeus, Lund (SE)

Correspondence Address: BIRCH STEWART KOLASCH & BIRCH, PO BOX 747, FALLS CHURCH, VA, 22040-0747, US

(21) Appl. No.: 10/101,927

(22) Filed: Mar. 21, 2002

Related U.S. Application Data
(60) Provisional application No. 60/277,285, filed on Mar. 21, 2001.
(60) Provisional application No. 60/281,786, filed on Apr. 6, 2001.

(51) Int. Cl. H04K 1/00

(52) U.S. Cl. 705/59; 705/60

(57) ABSTRACT

A method and system includes sharing revenue between a plurality of parties providing a technology service in which an end user uses a position indicia reading stylus to collect position information from a product having position identifying indicia thereon and a network infrastructure communicates a signal representing, or derived from, position information collected from said stylus to a network node that performs a technological service based on the signal. An agreement is formed between the parties regarding a percentage of revenue that each party should receive. The service is provided via the network infrastructure to end users for a fee. The fee is collected from the end users, and a portion of the fee is distributed to each party based on the percentage of revenue allocated to each party in the agreement.

### CROSS-REFERENCE TO RELATED APPLICATION

This application claims priority under 35 U.S.C. §1.119(e) of U.S. Provisional Application No. 60/277,285 filed on Mar. 21, 2001 and U.S. Provisional Application No. 60/281,786 filed on Apr. 6, 2001, the entire contents of which are herein incorporated by reference.

### BACKGROUND OF THE INVENTION

1. Field of the Invention

The present invention relates generally to a system and method of revenue sharing between service and technology providers of a data transmission and communications system and, more particularly, to a system and a method of distributing revenue between the “partners” necessary to facilitate a mobile paper based service initiated by an end user.

2. Background Information

Computers and other communications devices that are connected via a network, such as the Internet, allow individuals to electronically communicate, access information and services, and conduct various business transactions. For example, Email has become a predominant tool for message transmission for both personal use and for businesses, and the use of Internet web sites for accessing information, goods, and services has become a part of daily life for many people in recent years.

The manner in which a network may be accessed, and the user interface employed, can vary. For example, a user often accesses a mobile phone network after manipulating keys on the mobile phone, or in some instances through voice commands. Network access through a personal digital assistant (PDA) may be achieved using a stylus on a touch-sensitive surface, and network access through a personal computer or laptop is often achieved through a keyboard or mouse.

As input technology has advanced, and as network access becomes easier through the proliferation of, for example, localized proximity oriented communication/network access protocols like Bluetooth, conventional network based communications and transactions might be impeded by input devices and interfaces that users find cumbersome or awkward. Further, with the diversity of fee based services provided over, for example, the Internet, and the corresponding diversity of input technologies or at least types of inputs or destinations which a given input technology may access, and with the relative infancy of such fee based services, problems may arise in proliferating a particular input technology to users and/or prompting its use to a level that encourages the provisioning of new services.

In particular, when more than one party or service provider is needed for implementation of a new input technology with an associated service, it may be difficult to balance the financial incentives needed to persuade the required parties to participate in the operation and implementation.

Recognizing this problem, a new form of input technology characterized by “digital paper” and a stylus, the inventor of this application has developed a business model which establishes “partnerships” between the parties needed to provide and execute services for mobile end users of the input technology. Such partnerships provide revenue sharing for transaction-based, flat rate, subscription, and/or license fees associated with offered services and/or supporting network infrastructure. According to this business model, the partner network for the new input technology expands as new partners introduce services for the input technology, thereby promoting proliferation of the input technology and introduction of new and advanced services.

### SUMMARY

One embodiment of the present invention includes a method of sharing revenue between a plurality of parties providing a technology service in which an end user uses a position indicia reading stylus to collect position information from a product having position identifying indicia thereon and a network infrastructure communicates a signal representing, or derived from, position information collected from said stylus to a network node that performs a technological service based on said signal. The method includes forming an agreement between the parties regarding a percentage of revenue that each party should receive; providing the service via the network infrastructure to end users for a fee; collecting the fee from the end users; and distributing a portion of the fee to each party based on the percentage of revenue allocated to each party in the agreement.

Another embodiment of the invention includes a system of sharing revenue between a plurality of parties providing a service in which an end user uses a position indicia reading stylus to collect position information from a product having position identifying indicia thereon and a network infrastructure communicates a signal representing, or derived from, position information collected from said stylus to a network node that performs a technological service based on said signal. The system includes means for establishing predetermined percentages of revenue allocated to each party in the plurality of parties; means for charging a fee allocated to each user for the use of the provided service; means for collecting the fee from each user to generate revenue and means for distributing the collected revenue so that each party in the plurality of parties receives a portion of the revenue equal to the predetermined allocated percentage.

Another embodiment of the invention includes an apparatus for calculating an allocation of revenue to a plurality of parties providing a service in which an end user uses a position indicia reading stylus to collect position information from a product having position identifying indicia thereon and a network infrastructure communicates a signal representing, or derived from, position information collected from said stylus to a network node that performs a service based on the signal. The apparatus includes a database for tracking revenue information related to the service and a processor for calculating revenue to be allocated to each party of the plurality of parties as a function of the revenue information and a percentage of revenue allocated to each party of the plurality of parties.

### BRIEF DESCRIPTION OF THE DRAWINGS

Further objects, features and advantages of the invention will become apparent from the detailed description given below with reference to the accompanying drawings, which are incorporated in and constitute part of the specification and, together with the description, explain the features and principles of the invention. In the drawings:

FIG. 1 is a diagram of an exemplary network environment to which principles of the present application may be applied;

FIG. 2 is a diagram showing exemplary features of the network environment of FIG. 1 in more detail to demonstrate a possible end user environment to which principles of the present application may be applied;

FIG. 3 is a diagram showing an exemplary flow of information among a plurality of network nodes in the context of the exemplary end user environment shown in FIG. 2;

FIG. 4. is a flow diagram depicting the process of forming the revenue sharing system and method of one embodiment of the invention;

FIG. 5 is a flow diagram depicting the responsible parties in the revenue sharing partnership agreement according to one embodiment of the present invention;

FIG. 6 is a flow diagram depicting the negotiation relationships between the parties of FIG. 5;

FIG. 7 is a flow diagram depicting the percentage of revenue allocation to the parties in FIGS. 5 and 6 according to one embodiment of the present invention;

FIG. 8 is a flow diagram depicting a payment provider as part of the service provider and links to the network, end users and credit card companies, according to one embodiment of the present invention;

FIG. 9 is a flow diagram depicting the collection and distribution of revenue to the parties of FIG. 5 according to one embodiment of the present invention using an independent clearing house; and

FIG. 10 is a general block diagram of an exemplary arrangement for calculating an allocation of revenue according to an embodiment of the present invention.

### DETAILED DESCRIPTION

The present invention is a revenue sharing system and a method for technology and service providers in a communications network to share revenue. The present invention will be described below with reference to the accompanying drawings.

1. Exemplary Network Arrangement and Services

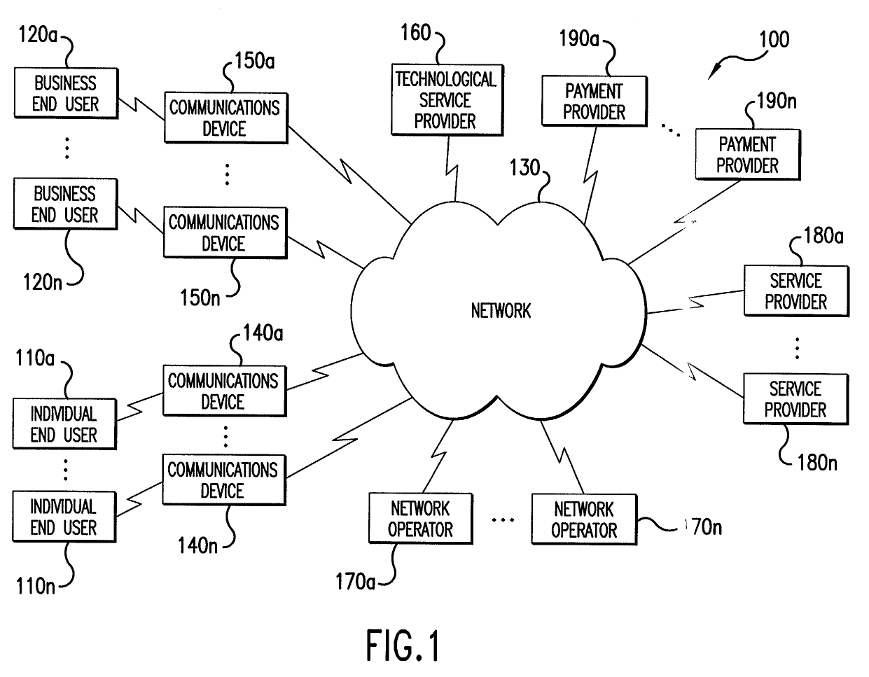

FIG. 1 illustrates an exemplary network environment to which principles of the present invention may be applied. As shown in FIG. 1, an exemplary network environment 100 includes the following main components: (1) individual end users 110a-110n; (2) business end users 120a-120n; (3) a network 130; (4) communications devices 140a-140n, respectively providing communications connections between the individual end users 110a-110n and the network 130; (5) communications devices 150a-150n, respectively providing communications connections between business end users 120a-120n and the network 130; (6) a technological service provider 160; (7) network operators 170a-170n; (8) service providers 180a-180n; and (9) payment providers 190a-190n. It should be readily apparent that the number and types of components in network environment 100 are not limited to what is shown in FIG. 1. For example, there may be several technological service providers.

The communications devices 140a-140n, 150a-150n, the technological service provider 160, the network operators 170a-170n, the service provider 180a-180n, and payment providers 190a-190n are connected via the network 130, thereby enabling the exchange of information and services among these components. The network 130 may be any type of network or a combination of networks, for example having cellular wireless, landline, and/or satellite components, individually or in combination. Furthermore, although the technological service provider 160, the network operators 170a-170n, and the service providers 180a-180n are shown as discrete entities of the network environment 100, it should be recognized that the functionality of these components, discussed below may be consolidated, such that a single entity may function as both a technological service provider and a service provider, both a technological service provider and a network operator, both a service provider and a network operator, or as a technological service provider, a service provider, and a network operator.

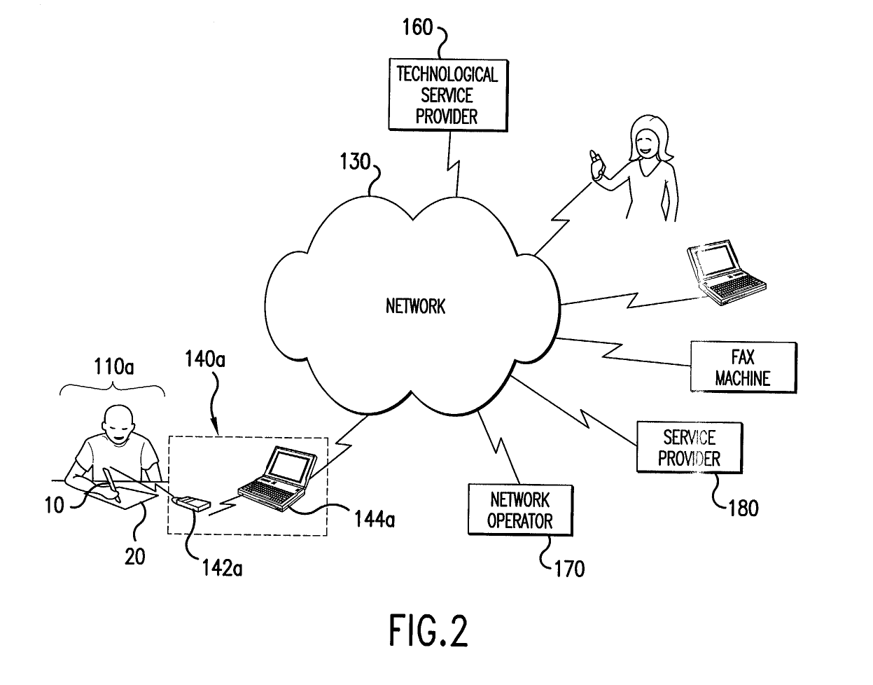

Network operators 170a-170n may be entities that provide end users 110a-110n, 120a-120n, technological service provider 160, service providers 180a-180n, and payment providers 190a-190n with channels of the network 130 over which to communicate, e.g., communications services providers. αβ FIG. 2 is a diagram showing components of the network environment of FIG. 1 in more detail to demonstrate a possible end user environment to which principles of the present application may be applied. According to the exemplary end user environment shown in FIG. 2, an individual end user 110a uses a position indicia reading hand held device such as a pen or stylus 10 that is able to read position indicia from a surface 20. The surface 20 that has position defining indicia thereon will be referred to herein as “digital paper,” although it should be recognized that the surface 20 is not strictly limited to a paper product. As the user moves the stylus 10 across the digital paper 20, the stylus 10 detects position defining indicia to determine position/movement of the stylus 10 on the digital paper 20 and sends a signal representing, or derived from, position/movement of the stylus 10 via the communications device 140a associated with the individual end user 110a and the network 130 to the technological service provider 160, a network operator 170, a service provider 180, and/or other entities connected to the network 130. In the exemplary end user environment illustrated in FIG. 2, the communications device 140a includes a mobile phone 142 and a personal computer 144a. This arrangement for the communications device 140a is just one possibility. As described in greater detail below, the stylus/digital paper input technology that is the subject of this application enables a variety of services and applications.

The digital paper 20 may have an absolute-position-defining background pattern printed thereon, e.g., printed on the paper 20 using carbon-based black ink or another ink visible by infrared light. Such a pattern of small dots with a nominal spacing between the dots of, e.g., 0.3 mm may be printed on paper of any desired size and shape. The dots may be slightly displaced from a virtual grid structure to form areas or windows, for example including 6×6 dots and occupying a dimension of 2 mm×2 mm. Such an area, which may be called a “symbol,” uniquely defines an absolute position at an imaginary surface. Since each dot may occupy four different positions and since there are 36 dots, the total combination of positions that can be coded is 2⁷², which corresponds to a surface area exceeding 60×10⁶ km². In this way, the imaginary surface may be divided into numerous sub-surfaces of various sizes, some of which may be pre-defined for certain applications, such as those discussed below, while others may be licensed to companies and/or authorities. A more detailed description of position defining characteristics for a particular form of digital paper 20 is provided in U.S. application Ser. No. 09/580,338, titled “Position Determination,” filed May 26, 2000 and U.S. application Ser. No. 09/676,914, titled “Position Determination II—Graphic,” filed Oct. 2, 2000, such description being herein incorporated by reference. The area within a sub-surface can be used for a range of applications, each with its own assigned functionality. In addition to position-defining portions, portions of the digital paper 20 may be provided with dot patterns that represent particular functions, commands, or information fields.

The stylus 10 may be a “digital pen” having the following elements: (1) a camera including light emitting diodes that illuminate dots of the surface 20, e.g., via infrared light, and takes digital snapshots, e.g., at a rate of 100 per second, to capture images of the illuminated dots; (2) an image processor that calculates, e.g., in real-time, the position/movement/orientation of the stylus 10 on the surface 20 based on the dot pattern images captured from the surface 20; (3) a memory for storing coordinate information generated by the image processor, e.g., sufficient to store several hand-written pages; (4) a communication element, e.g., a wireless Bluetooth RF transceiver or an infrared transceiver, for sending/receiving information to/from the associated communications device 140a, or directly to the network 130; (5) an ink cartridge; (6) a force sensor that measures stylus tip force; and (7) a battery. One of skill in the art will recognize that the stylus 10 may include additional or fewer components. It should also be recognized that the stylus 10 may include a transmitter for communicating directly over a network, instead of merely a transmitter for relaying information over a network through an intermediary communications device, such as a mobile telephone, or a network connected computer or PDA. The information transfer by the transceiver of the stylus 10 does not need to be wireless, but instead may be by cable. A more detailed description of a position determining function that may be performed by the stylus 10 is provided in U.S. application Ser. No. 09/580,338, titled “Position Determination,” filed May 26, 2000 and U.S. application Ser. No. 09/676,914, titled “Position Determination II—Graphic,” filed Oct. 2, 2000, such description being herein incorporated by reference.

Carbon-based black, or other suitable, ink which may form the dot patterns on the surface 20 may be capable of absorbing infrared light emitted from the stylus 10 so that the position identifying patterns on the surface 20 may be read by the stylus 10 regardless of other colors or noncarbon-based black ink, printed thereon, provided the other colors do not absorb infrared light. In addition to detecting position/movement/orientation of the stylus 10 and recognizing function/field-identifying patterns, the stylus 10 may include intelligent character recognition (ICR) capabilities for interpreting letters and characters written in certain fields of the digital paper 20, e.g., for reading handwritten email addresses, fax numbers, or phone numbers. Although an individual end user 110a is illustrated in FIG. 2, business end users 120a-120n may likewise use a position indicia reading stylus 10 and a surface 20 having position defining indicia thereto to conduct business functions.

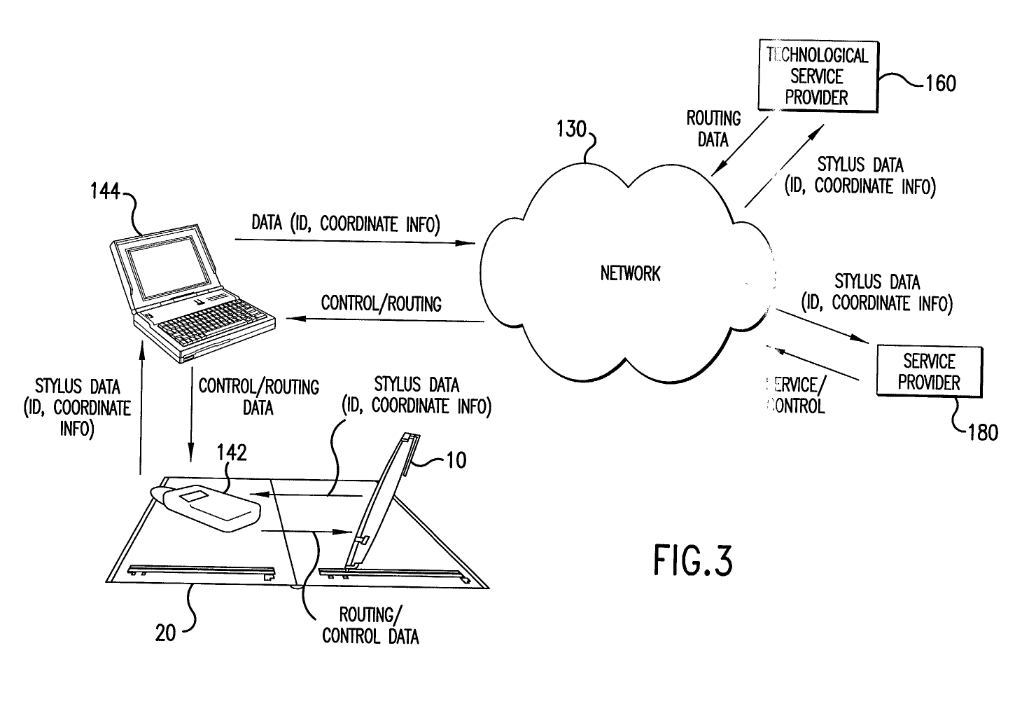

FIG. 3 illustrates an exemplary flow of information for elements of the end-user/network environment shown in FIG. 2. As seen in FIG. 3, the stylus 10 sends stylus data, which may include a stylus-specific identification (ID) and coordinate information, which represents stylus position/movement data, to the technological service provider 160 via the network 130 and the intermediate communications device 140a, which includes a mobile phone 142a, e.g., with a Bluetooth RF transceiver, and a computer 144a in the exemplary end user environment of FIG. 3. Position information may include, for example, coordinates in the imaginary surface. It should be realized that the stylus 10 may store the coordinate information and/or other stylus data in memory for sending at a later occasion/time. The technological service provider 160 may use the stylus-specific ID information for various purposes, e.g., to access, verify, and update account information of individual end user 110a and/or to update billing/account information. The information transmitted by the stylus 10 may not be limited to stylus ID and coordinate information, depending on the capabilities of the stylus 10. For example, if the stylus 10 is provided with ICR capability, the stylus 10 may transmit text information.

The technological service provider 160 utilizes the coordinate information received from the stylus 10 to determine the type of service or transaction the user is requesting, e.g., based on the sub-surface associated with the coordinate information in the imaginary surface. Based on this determination, the technological service provider 160 identifies the service provider that will handle the service or transaction and sends routing data to the stylus 10 via the network 130 and the communications device 140a associated with the end user 110a. The routing data instructs the stylus 10 where, and in what format, to send the previously stored coordinate information, e.g., providing the stylus 10 with an Internet Protocol (IP) address for the server associated with the appropriate service provider 180. Next, the stylus 10 sends the previously-stored coordinate information to the appropriate service provider 180 via the communications device 140a and the network 130. Upon receiving and processing the coordinate information from the stylus 120, the service provider 180 may send control data back to the stylus 10, e.g., indicating that the service/transaction is complete so that the stylus 10 may clear its memory.

In addition to controlling routing and managing end user account information, it should be recognized that the technological service provider 160 may perform additional “value-added” services. For example, the technological service provider 160 may translate the coordinate information received from the stylus 10 into a format, e.g., text data, that may be used to achieve the requested service. Furthermore, the technological service provider 160 may itself perform any necessary routing, for example by transmitting the coordinate information received from the stylus 10 to the appropriate service provider.

The arrangements illustrated in FIGS. 2-3, and variations thereof, may support a variety of communications services and commercial transactions, such as:

Facsimile Service—The end user 110 may write a note or sketch on digital paper 20, input a facsimile number in a designated field of the digital paper 20, or at a keyboard, e.g., associated with a mobile telephone, and check a portion of the surface 20 designated for a “send” function. The technological service provider 160 receives identification and coordinate data from the stylus 10, recognizes that the end user 110 has requested facsimile service, and sends appropriate routing information to the stylus 10, e.g., routing information for a service provider 180 that supports facsimile service. Upon receiving routing information from the technological service provider 160, the stylus 10 sends the previously-stored coordinate information to the service provider 180 supporting facsimile service, which converts the coordinate information into a facsimile transmission to the designated fax number.

Email—The end user 110 may write a note or sketch on the digital paper 20, input an email address in a designated field of the digital paper 20, or at a keyboard, e.g., associated with a mobile telephone, and check a portion of the digital paper 20 designated for a “send” function. The technological service provider 160 will receive identification and coordinate data from the stylus 10, recognize that the end user 110 has requested email service, and send appropriate routing information to the stylus 10, e.g., routing information for a service provider 180 that supports email service). Upon receiving routing information from the technological service provider 160, the stylus 10 sends the previously-stored coordinate information to the service provider 180 supporting email service, which converts the coordinate information into an email message that is sent to the designated email address.

Short Message Service (SMS)—The end user 110 may write text on the digital paper 20, input a telephone number for an SMS-enabled device, e.g., a GSM mobile phone, in a designated field of the digital paper 20, or at a keyboard, e.g., associated with a mobile telephone, and check a portion of the digital paper 20 designated for a “send” function. The technological service provider 160 receives identification and coordinate data from the stylus 10, recognizes that the end user 110 has requested SMS, and sends appropriate routing information to the stylus 10, e.g., routing information for a service provider 180 or network operator 170 that supports SMS. Upon receiving routing information from the technological service provider 160, the stylus 10 sends the previously-stored coordinate information to the network operator 170 or service provider 180 supporting SMS, which converts the coordinate information into a text message that is sent to the designated SMS-enabled device.

Commercial Transactions—The end user 100 may purchase goods or services using the stylus 10 and the digital paper 20. For example, an advertisement for flowers may be printed on the digital paper 20 with portions containing positioning identifying dot patterns. By touching an appropriate part of the advertisement with the stylus 10 and filling in order information, e.g., fields for name, address, credit card, delivery destination, etc., an order for flowers may be placed to a local flower shop, where the order can be filled.

Business Applications—Business end users 120a-120n may use the stylus 10 and the digital paper 20 in a manner similar to individual end users 110a-110n. A business end user 120 may either be an employee of or otherwise affiliated with a service provider in the arrangement. For example, a business end user 120a may be an employee of a parcel delivery service having an inventory system, and equip each delivery personnel with a stylus 10 and digital paper 20 for transmitting delivery status information to a host computer connected to the network 130. Depending on the particular business application, involvement of the technological service provider 160 may be optional.

2. Revenue Sharing

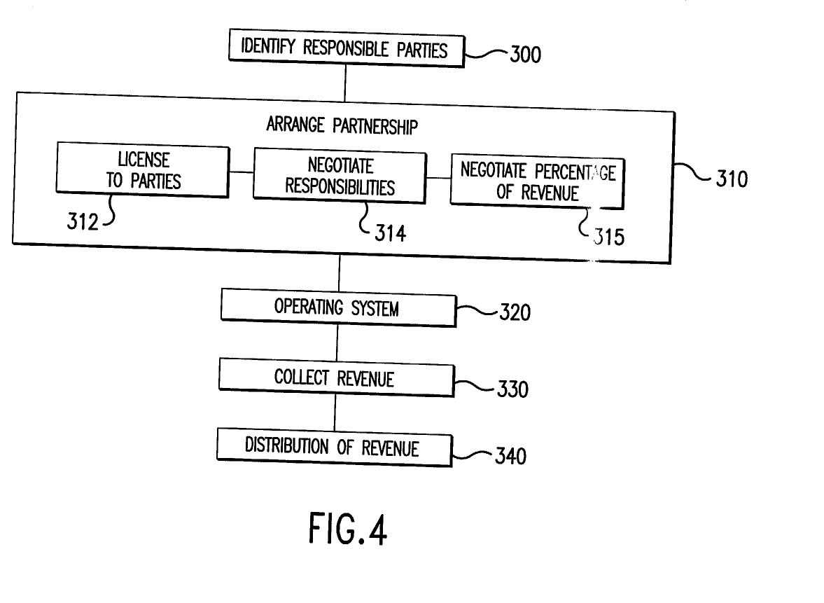

According to the invention, a system and method of sharing revenue between the responsible parties of the stylus/digital paper-based technology and services has been developed. The system may be implemented according to the steps shown in FIG. 4.

FIG. 4 depicts one example of an implementation process for the system and method of sharing revenue. Initially, in step 300, the parties needed for operation of the stylus/digital paper-based technology and services are identified. The concept owner 230, which may be a party owning the relevant intellectual property, such as proprietary rights to the imaginary surface and/or its use, is responsible for identifying the responsible parties. Once the parties are identified, the concept owner 230 arranges a partnership 310.

The partnership may be formed based on several considerations. For example, the considerations may include negotiations of licenses of intellectual property rights 312 to the responsible parties; negotiations of responsibilities of responsible parties 314; and negotiations of the percentage of revenue 315 each responsible party may receive.

Once the parties are aware of their roles, responsibilities and percent of revenue, the system and method of sharing revenue is placed in operation in step 320. As the stylus/digital paper-based technology and services are used, revenue is collected in the revenue collection step 330. The collected revenue may correspond to various types of user fees such as fees per use of the technological service provider 160, fees per use for the services provided by a service provider 180a-180n, subscription fees for services provided by the technological service provider 160 and service provider 180a-180n and fees for a period of time during which the technological service provider 160 and service provider 180a-180n may be utilized, etc. The fees also may encompass license fees for the use of the stylus/digital paper-based technology and services. Finally, in the distribution of revenue step 340, the collected revenue is distributed to the responsible parties according to the percentages negotiated in step 310.

A. Responsible Parties

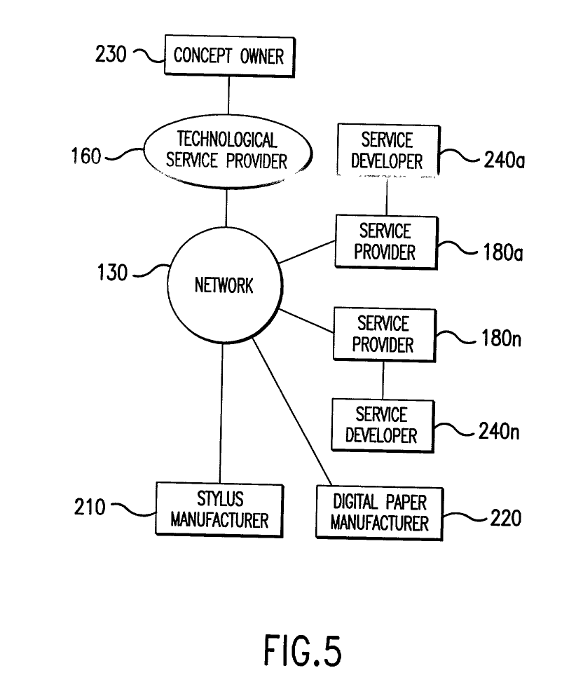

FIG. 5 depicts responsible parties according to one embodiment of the present invention. In this embodiment, the responsible parties may include service providers 180a-180n, technological service provider 160, pen manufacturer 210, digital paper manufacturer 220, concept owner 230 and service developers 240a-240n similar to the embodiment discussed above. Anyone of these parties may provide multiple services.

The concept owner 230 is the party or parties, which own the intellectual property rights surrounding the stylus/digital paper-based technology and services. The concept owner 230 provides licenses to the other parties for the use of its patented technology.

As described above, technological service provider 160 provides a mapping look up service to map the coordinates on the digital paper to matching sub-surfaces. In the discussions that follow, the technological service provider 160 may be the same party as the concept owner 230. However, in other embodiments, the technological service provider 160 may license the property rights to the mapping look up service from the concept owner 230 and function as an independent entity.

The stylus and digital paper manufacturers 210 and 220, respectively, produce, market and distribute the stylus 10 and digital paper 20 as licensed by the concept owner 230.

The service developers 240a-240n develop new applications for the stylus/digital paper-based technology. Thus, the partnership network expands as additional parties develop digital paper/stylus services and enhancements, thereby promoting proliferation of the digital paper/stylus as a form of input technology. The new services are provided to users via the network 130. Additionally, the digital paper manufacturers 220 may produce a new type of digital paper to support the new service. The new digital paper may differ from the existing paper, for example by the color or graphical depictions on the paper and the shape. To foster the growth of new services, the concept owner 230 will license its intellectual property rights. The new services may be developed using application development kits produced by the concept owner 230. A detailed description of Application Development Kits is provided in U.S. application Ser. No. 09/941,871, entitled “Application Development Kit”, filed Aug. 30, 2001, such description being herein incorporated by reference.

The service providers 180a-180n may provide the end users 110, 120 with the services developed by the concept owner 230 and/or technological service provider 160. Examples of these services include the facsimile service, email, SMS, commercial applications and business applications discussed above. The service providers 180a-180n also provide the users with any services developed by the service developers 240a-240n.

The service providers 180a-180n may set their own price for the services provided. However, the service providers 180a-180n may transfer a percentage of income to the partnership. The basis of the percentage of income could either be the number of user transactions, flat, e.g., a monthly fee or some combination thereof. Further, the amount charged to the users may differ based on the service provided.

As in FIG. 1, the arrangement of the responsible parties is not limited to that of FIG. 1 or 4. Rather, services/responsibilities could be combined between parties.

B. Creation of Partnership

In step 310 the concept owner 230 is responsible for initiating the formation of the partnership among the responsible parties. The partnership is formed primarily through negotiations based on licenses to parties 312, negotiated responsibilities of parties 314, and negotiated percentage of revenue 315. However, other factors may be considered in the negotiations such as time and quantities. Also, in negotiating the percentage of revenue each party should have, it is desirable that the percentage will result in profit for the party after considering factors such as investment costs, license rights, overhead responsibilities such as marketing and billing and service provided.

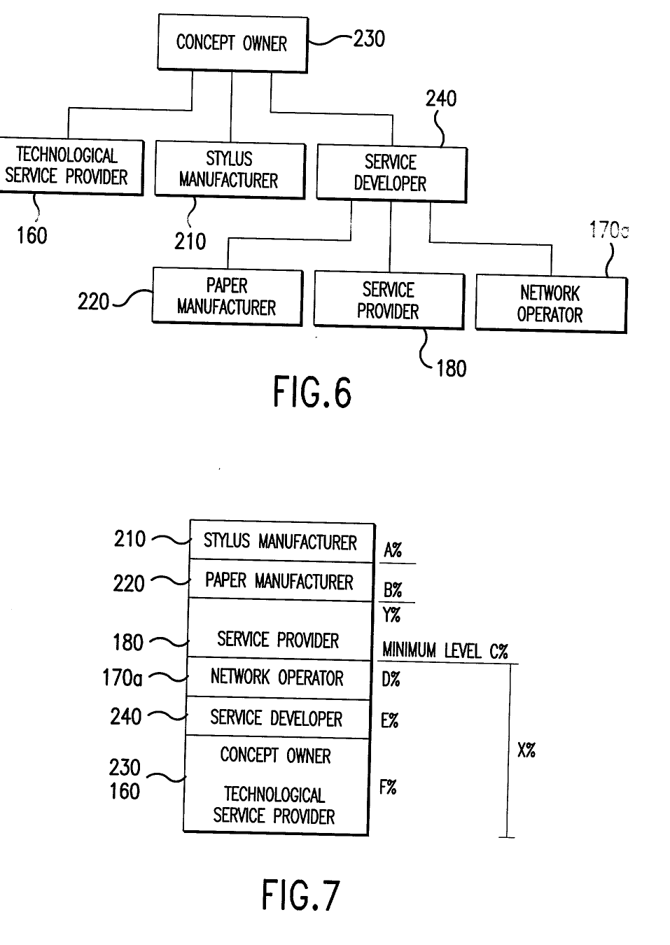

The flow of negotiations is depicted in FIG. 6 and the system percentages of revenue are depicted in FIG. 7. As shown in FIG. 6, the concept owner 230 has a direct relationship with the technological service provider 160, e.g., concept owner 230 may even be the technological service provider, as discussed above and below the stylus manufacturer 210 and the service developer 240. The service developer 240 is given the responsibility by the concept owner 230 to allocate revenue between the paper manufacturer 220, service provider 180 and network operator 170.

The percentage revenue allocated to each of the parties will also differ based on the type of service provided. There are at least three types of services. Core services are such as those discussed above which have been developed by the concept owner 230 on for example basic paper products. Additionally, core services may be continually introduced by the concept owner 230. Open services are those developed by some other party such as the service developer 240. Lastly, there are open core services which utilize a core service but with a link to an open service.

Different revenue sharing arrangements may be applicable to each type of service. For example, the service developer 240 and service provider 180 may receive a relatively higher percentage of the revenue when end users 110, 120 use any open services that these parties developed, while the service developer 240 and service provider 180 may receive a relatively lower percentage of revenue when end users use the core services which have been developed by the concept owner 230. As a result, a different partnership arrangement for each category of open, core and open core services may be in operation simultaneously.

Although different revenue sharing arrangements may operate simultaneously, in each arrangement, the concept owner 230 sets predetermined revenue allocation percentages for certain responsible parties. FIG. 7 depicts one example of the allocation of percentage of revenue on percentages. The concept owner 230 sets A % for the stylus manufacturer 210 and B % for the paper manufacturer 220. Additionally, the concept owner 230 sets C %, which is a minimum level that the combination of the allocation of revenue percentage for the network operator 170a, service developer 240 and concept owner 230/technological service provider 160 should meet.

As shown in FIG. 7, the service provider 180 receives Y %. The relationship between the percentages is such that

100%=A %+B %+Y %+X %,

where X %=D %+E %+F % and X %>C %.

For the embodiment depicted in FIGS. 4 and 7 and for open services, the minimum level C % is set at a predetermined level. Further, as the configurations of the parties change the minimum level C % changes accordingly. For example, if the concept owner 230, technological service provider 160 and service provider 240 are all encompassed by the same party, the minimum level may increase.

C. Operation of the Stylus/Digital-Paper System

As the stylus digital paper system operates, end users may be able to use the open, core and open core services. As a result, at least three revenue sharing partnerships may be functioning simultaneously.

D. Collection of Revenue

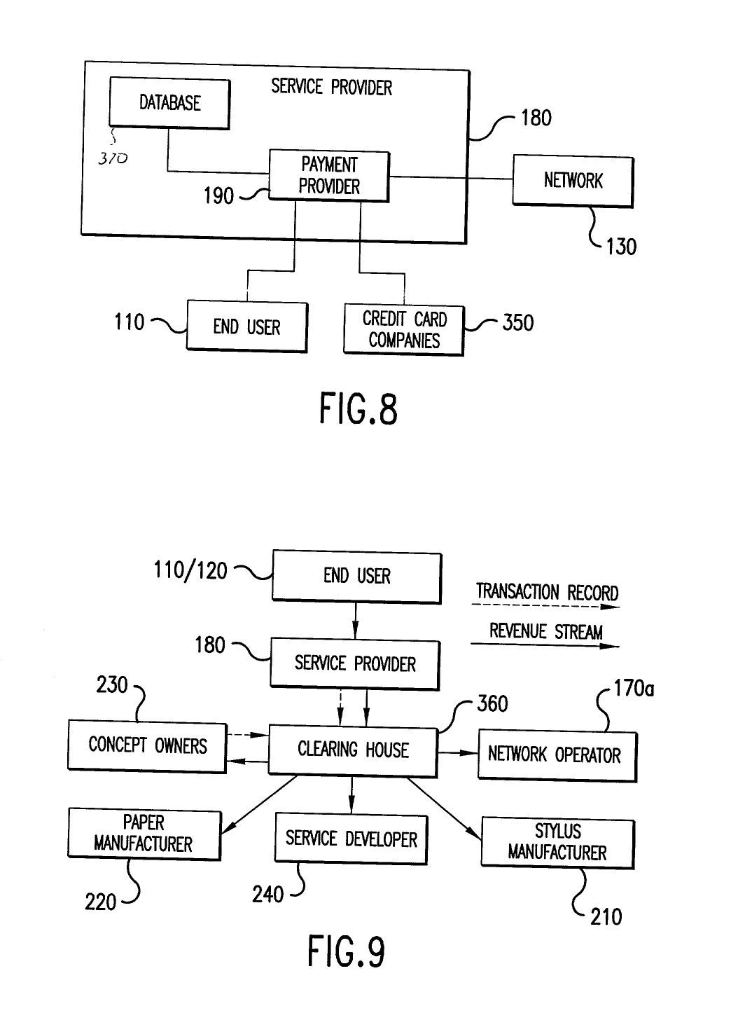

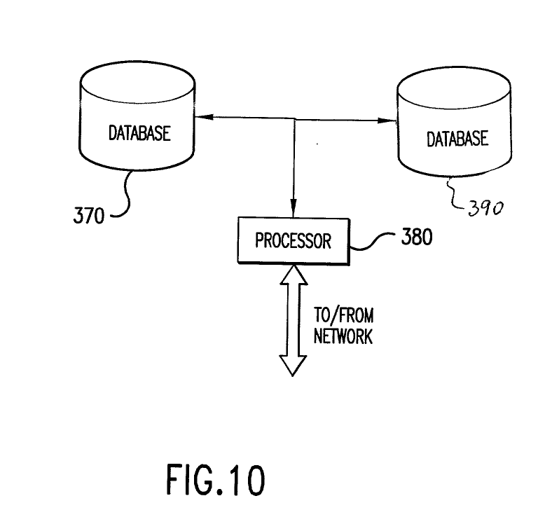

According to a preferred embodiment of the present invention, revenue will be collected for each time or tick a user of the stylus accesses the technological service provider 160 to gain mapping look up services. The service provider 180 is responsible for tracking the type and quantity of services provided to each user and collecting payments from each user. To perform the tracking, the service provider 180 may utilize a database 370, as shown in FIGS. 8 and 10. The database 370 may record the number and type of services provided to each user 110/120.

According to the preferred embodiment of the invention, one bill will be issued per stylus. The bill may be in the form of a flat fee for a period of use or a charge per tick or a combination thereof. The charges may be based on the types of services used for each tick or subscribed to for the billing period.

The service provider 180 may ensure the revenue is collected by directing an independent payment provider 190 or the collections may be performed by the service provider 180 by incorporating the payment provider into the service provider 180. In either case, as shown in FIGS. 1 and 8 the payment provider 190 also has communications to the end users 110 and 120. The link between the payment provider 190 and the end users may be either direct as in FIG. 8 or via the network as in FIG. 1.

The payment provider 190 may have billing systems so that the end user may pre-pay for the stylus-digital paper system, pay via credit card company 350 and a billing system which allows users to pay for use over a period of time such as a month. FIG

E. Distribution of Revenue

Once the revenue is collected by the payment provider 190, it is also the responsibility of the concept owner 230 to ensure that the revenue is distributed according to the arranged percentages. The concept owner 230 may perform this function in variety of ways. For example, the concept owner 230, via the technological service provider 160, may act as a revenue clearing house 360 itself or direct a stand alone entity to act as the revenue clearing house 360.

FIG. 9 depicts the flow of revenue from the end users 110, 120 throughout the stylus/digital paper system utilizing an independent clearing-house 360. As shown, the revenue flows from the end users 110/120 through the service provider 180. The service provider 180 may be responsible for determining its share of the revenue based on the partnership agreements and the number and type of transaction bought by the end users. The service provider 180 may then allocate itself the appropriate share of revenue and pass the remaining portion of the revenue to the clearing-house 360 along with an accounting of the transactions and services provided to each user by the service provider 180. Similarly, the concept owner 230/technological service provider 160 may provide the clearing-house with an accounting of the ticks per user. The concept owner 230/technological service provider 160 may access a database 370 of individual service providers or maintain its own database to track the number of ticks per user. The clearing house 360 uses the information on the ticks per user, services provided to each user and the agreed upon percentages to determine how much revenue the network operator, stylus manufacturer, service developer, paper manufacturer and concept owner 230/technological service provider 160 should receive and distributes the revenue accordingly.

With reference to FIG. 10, the clearinghouse 360, concept owner 230, and/or individual service providers may employ a processor 380 to calculate the appropriate distribution of revenue. As shown in FIG. 10, the processor 380 is in communication with databases 370 and 390. Database 390 may store detailed revenue information, e.g., the total revenue collected for all services over a time period, e.g., a month, quarter, etc., revenue collected for each individual service over a time period, etc. The processor 380 may access the databases 370 and/or 390 over network 130 or locally. The processor 380 may use the information recorded in database 370 for the amount and type of services provided to each end user 110/120; revenue information from database 390; and the agreed upon percentages to determine how much revenue the network operator, stylus manufacturer, service developer, paper manufacturer and concept owner 230/technological service provider 160 should receive. The revenue is distributed to the responsible parties accordingly. It should be recognized that the function of determining revenue shares could be performed by some other party.

3. Advantages

The method and system of revenue sharing according to the present invention has many advantages. For example, the inclusion of manufacturers of the stylus and digital paper in the arrangement provides an avenue for these parties to receive revenue from the use of the digital paper and stylus. This provides more financial incentive for these parties to be involved over the long run, which would not exist if the parties merely received profits from selling the stylus and digital paper. Further, the opportunity for the responsible parties to develop new applications for the stylus/digital paper technology provides the manufacturers with potential new products to produce and thereby receive more profits.

The use of one bill per stylus encompassing the charges associated with all the services and technology provided by the various entities is advantageous. For example, if a user received two bills per tick with one bill correlating for example to the network operator service and a second bill correlating to the mapping look up service provider, a user may not use or purchase the stylus due to the inconvenience of the billing system.

Additionally, the revenue sharing arrangement removes the risk of bearing the initial start up costs from any one party. Still further, the revenue sharing arrangement described herein provides for an expanding partner network as new parties introduce services for the digital paper/stylus technology, thereby promoting proliferation of the digital paper/stylus as a form of input technology and introduction of new and advanced services.

It is noted that this revenue sharing method and system has been described in relation to data communications using the stylus/digital paper technology services.

4. Reference to Related Applications

Co-pending with the application for this patent are applications entitled Systems and Methods for Information Storage based on Swedish Application No. 0000947-2, filed Mar. 21, 2000, U.S. Provisional Application No. 60/207,839, filed May 30, 2000, and U.S. Utility application Ser. No. 09/812,885, filed on Mar. 21, 2001; Secured Access Using a Coordinate System based on Swedish Application No. 0000942-3, filed Mar. 21, 2000, U.S. Provisional Application No. 60/207,850 filed on May 30, 2000, and U.S. Utility application Ser. No. 09/813,115, filed on Mar. 21, 2001; System and Method for Printing by Using a Position Coding Pattern based on Swedish Application No. 0001245-0, filed on Apr. 5, 2000, U.S. Provisional Application No. 60/210,651, filed on Jun. 9, 2000, and U.S. Utility application Ser. No. 09/812,905, filed on Mar. 21, 2001; Apparatus and Methods Relating to Image Coding based on Swedish Application No. 0000950-6, filed on Mar. 21, 2000, U.S. Provisional Application No. 60/207,838, filed on May 30, 2000, and U.S. Utility application Ser. No. 09/812,901, filed on Mar. 21, 2001; Apparatus and Methods for Determining Spatial Orientation based on Swedish Application No. 0000951-4, filed on Mar. 21, 2000, U.S. Provisional Application No. 60/207,844, filed on May 30, 2000, and U.S. Utility application Ser. No. 09/812,902, filed on Mar. 21, 2001; System and Method for Determining Positional Information based on Swedish Application No. 0000949-8, filed Mar. 21, 2000, U.S. Provisional Application No. 60/207,885, filed on May 30, 2000, and U.S. Utility application Ser. No. 09/812,900, filed on Mar. 21, 2001; Method and System for Transferring and Displaying Graphical Objects based on Swedish Application No. 0000941-5, filed Mar. 21, 2000, U.S. Provisional Application No. 60/208,165, filed May 31, 2000, and U.S. Utility application Ser. No. 09/812,892, filed on Mar. 21, 2001; Online Graphical Message Service based on Swedish Application No. 0000944-9, filed Mar. 21, 2000, U.S. Provisional Application No. 60/207,881, filed May 30, 2000, and U.S. Utility application Ser. No. 09/813,117, filed on Mar. 21, 2001; Method and System for Digitizing Freehand Graphics With User-Selected Properties based on Swedish Application No. 0000945-6, filed Mar. 21, 2000, U.S. Provisional Application No. 60/207,882, filed May 30, 2000, and U.S. Utility application Ser. No. 09/812,882, filed on Mar. 21, 2001; Data Form Having a Position-Coding Pattern Detectable by an Optical Sensor based on Swedish Application No. 0001236-9, filed Apr. 5, 2000, U.S. Provisional Application No. 60/208,167, filed May 31, 2000, and U.S. Utility application Ser. No. 09/812,906, filed on Mar. 21, 2001; Method and Apparatus for Managing Valuable Documents based on Swedish Application No. 0001252-6, filed Apr. 5, 2000, U.S. Provisional Application No. 60/210,653 filed Jun. 9, 2000, and U.S. Utility application Ser. No. 09/813,116, filed on Mar. 21, 2001; Method and Apparatus for Information Management based on Swedish Application No. 0001253-4 filed Apr. 5, 2000, U.S. Provisional Application No. 60/210,652, filed Jun. 9, 2000, and U.S. Utility application Ser. No. 09/826,015, filed on Apr. 5, 2001; Device and Method for Communication based on Swedish Application No. 0000940-7, filed Mar. 21, 2000, U.S. Provisional Application No. 60/208,166, filed May 31, 2000, and U.S. Utility application Ser. No. 09/813,114, filed on Mar. 21, 2001; Information-Related Devices and Methods based on Swedish Application No. 0001235-1, filed Apr. 5, 2000, U.S. Provisional Application No. 60/210,647, filed Jun. 9, 2000, and U.S. Utility application Ser. No. 09/812,907, filed on Mar. 21, 2001; Processing of Documents based on Swedish Application No. 0000954-8, filed Mar. 21, 2000, U.S. Provisional Application No. 60/207,849, filed May 30, 2000, and U.S. Utility application Ser. No. 09/813,112, filed on Mar. 21, 2001; Secure Signature Checking System based on Swedish Application No. 0000943-1, filed Mar. 21, 2000, U.S. Provisional Application No. 60/207,880, filed May 30, 2000, and U.S. Utility application Ser. No. 09/812,899, filed on Mar. 21, 2001; Identification of Virtual Raster Pattern, based on Swedish Application No. 0001235-1, filed Apr. 5, 2000, U.S. Provisional Application No. 60/210,647, filed Jun. 9, 2000, U.S. Utility application Ser. No. 09/812,907, filed on Mar. 21, 2001, and Swedish Application No. 0004132-7, filed Nov. 10, 2000, and U.S. Provisional Application No. 60/261,123, filed Jan. 12, 2001; Method and Arrangment in a Digital Communication System based on Swedish Application No. 0102232-6, filed Jun. 25, 2001; Communication Protocol based on Swedish Application No. 0102418-1, filed Jul. 5, 2001, and U.S. Provisional Application No. 60/303,814 filed Jul. 10, 2001; Method and System for Communications Service Revenue Collection based on U.S. Provisional Application No. 60/281,786, filed Apr. 6, 2001; Activation of Products with Embedded Functionality in an Information Management System based on Swedish Application No. 0104398-3, filed Dec. 27, 2001, and U.S. Provisional Application No. 60/346,295, filed Jan. 9, 2002; Server Unit in Computer Network based on Swedish Application No. 0102341-5, filed Jun. 29, 2001, and U.S. Provisional Application No. 60/303,041, filed Jul. 6, 2001.

The technical disclosures of each of the above-listed U.S. applications, U.S. provisional applications, and Swedish applications are hereby incorporated herein by reference. As used herein, the incorporation of a “technical disclosure” excludes incorporation of information characterizing the related art, or characterizing advantages or objects of this invention over the related art.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of sharing revenue between a plurality of parties providing a service in which an end user uses a position indicia reading stylus to collect position information from a product having position identifying indicia thereon and a network infrastructure communicates a signal representing, or derived from, position information collected from said stylus to a network node that performs a service based on said signal, the method comprising:
forming an agreement between the parties regarding a percentage of revenue that each party should receive;
providing the service via the network infrastructure to end users for a fee;
collecting the fee from the end users; and
distributing a portion of the fee to each party based on the percentage of revenue allocated to each party in the agreement.

2. The method of claim 1, wherein the parties comprise
a network operator for operating the network infrastructure;
a technological service provider connected to the network infrastructure and performing a look-up service based on position information received from said stylus;
a service provider connected to the network and in communication with the technological service provider via the network for providing the service to the user; and
a manufacturer for producing the stylus and/or the product needed for the user to initiate the service.

3. The method of claim 1, wherein
the step of forming the agreement comprises
a concept owner forming agreements with the parties, the concept owner being the owner of intellectual property rights in the service, product, and/or stylus.

4. The method of claim 4, wherein
the concept owner forms a first agreement with a first party for providing a first service in exchange for a license of intellectual property rights and a first percentage of the revenue, and
the first party forms a second agreement between the first party and a second party for providing a second service to the end user via the network infrastructure in exchange for a license of intellectual property rights and a second percentage of the revenue.

5. The method of claim 1, further comprising:
setting predetermined percentages of revenue for at least one party of the plurality of parties.

6. The method of claim 2, wherein the step of collecting the fee from the end users includes
the service provider collecting a transaction-based fee and/or flat fee from the end user.

7. The method of claim 2, wherein the step of distributing the portion of the fee to each party includes a clearing house for receiving the portion of fee from the service provider and allocating the received portion of the fee to the service provider and technological service provider.

8. The method of claim 2, wherein the step of forming an agreement includes forming an first agreement for core services and a second agreement for open service,
core services are services developed by the technology service provider, and
open services are services developed by a party other than the technology service provider.

9. A system of sharing revenue between a plurality of parties providing a service in which an end user uses a position indicia reading stylus to collect position information from a product having position identifying indicia thereon and a network infrastructure communicates a signal representing, or derived from, position information collected from said stylus to a network node that performs a service based on said signal, the system comprising:
means for establishing predetermined percentages of revenue allocated to each party in the plurality of parties;
means for charging a fee to each user for the provided service;
means for collecting the fee from each user to generate revenue; and
means for distributing the collected revenue so that each party in the plurality of parties receives a portion of the revenue equal to the predetermined allocated percentage.

10. The system of claim 9, wherein the parties in the plurality of parties comprises:
a network operator providing a network infrastructure;
a technological service provider connected to the network infrastructure and performing a look-up service based on position information received from said stylus;
a service provider connected to the network and in communication with the technological service provider via the network infrastructure for providing the service to the user; and
a manufacturer for producing the devices needed for the user to initiate the service.

11. The system of claim 10, wherein said means for charging a fee to each user for the provided service includes a payment provider controlled by the service provider.

12. The system of claim 10, wherein said means for distributing the collected revenue includes a clearinghouse for distributing the collected revenue as controlled by the technological service provider.

13. The system of claim 12, wherein said means for charging a fee to each user for the provided service includes a payment provider controlled by the service provider, and
the service provider retains a first portion of the collected fees equal to the predetermined percentage of the revenue allocated to the service provider and provides the clearing house with a first number of services provided by the service provider and the remaining second portion of the revenue.

14. The system of claim 13, wherein the clearing house receives the first number of transactions and second portion of the revenue from the service provider, receives a second number of technological services provided by the technological service provider, and distributes the second portion of the revenue to the technological service provider, manufacturer and network operator according to the predetermined allocated percentage of revenue for each party.

15. The system of claim 10, wherein predetermined percentages include a first percentage for core services and a second percentage for open services,
core services are services developed by the technology service provider, and
open services are services developed by a party other than the technology service provider.

16. The system of claim 10, wherein the means for establishing predetermined percentages of revenue allocated to each party in the plurality of parties includes an agreement between the technological service provider and at least one other party of the plurality of parties.

17. The system of claim 10, wherein the means for establishing predetermined percentages of revenue allocated to each party in the plurality of parties includes a first agreement between the technological service provider and the service provider and a second agreement between the service provider and at least one party of the plurality of parties other than the technological service provider.

18. An apparatus for calculating an allocation of revenue to a plurality of parties providing a service in which an end user uses a position indicia reading stylus to collect position information from a product having position identifying indicia thereon and a network infrastructure communicates a signal representing, or derived from, position information collected from said stylus to a network node that performs a service based on said signal, the apparatus comprising:
a database for tracking revenue information related to said service; and
a processor for calculating revenue to be allocated to each party of the plurality of parties as a function of said revenue information, and a percentage of revenue allocated to each party of the plurality of parties.
